(19) United States
(12) Patent Application Publication
(10) Pub. No.: US 2009/0052195 A1
(43) Pub. Date: Feb. 26, 2009

(54) SCATTERING MEMBER AND ORGANIC ELECTROLUMINESCENT DISPLAY DEVICE USING THE SAME

(75) Inventors: Ryuji SANETO, Minami-Ashigara-shi (JP); Yukito Saitoh, Minami-Ashigara-shi (JP); Tatsuho Nomura, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 12/195,708

(22) Filed: Aug. 21, 2008

(30) Foreign Application Priority Data
Aug. 21, 2007 (JP) 2007-215192
Oct. 10, 2007 (JP) 2007-264832
Aug. 20, 2008 (JP) 2008-212230

(51) Int. Cl. H01J 1/62; G02B 5/02; G02B 1/00

(52) U.S. Cl. 362/355; 313/505

(57) ABSTRACT

A scattering member includes: a binder; and a light scattering particle, wherein the scattering member is used for an organic electroluminescent display device; and an organic electroluminescent display device uses the scattering member.

### BACKGROUND OF THE INVENTION

1. Field of the Invention

The present invention relates to a scattering member used for enhancing the light emission efficiency of an organic electroluminescent display device, and an organic electroluminescent display device using the scattering member.

2. Description of the Related Art

The organic electroluminescent display device (also called as organic EL display device) is a self-emission type display device and used for the purpose of display or lighting. The organic EL display has an advantage in view of display performance, such as high visibility in comparison with conventional CRT or LCD or no viewing angle dependency, and is also advantageous in that the display can be lightweighted or thinned. On the other hand, the organic EL lighting has a possibility that lighting in a heretofore unrealizable shape can be realized by using a flexible substrate, in addition to the advantage such as lightweighting or thinning.

The organic EL display device or inorganic EL display device has excellent properties, but the refractive index of each of layers constituting the display device, including a light-emitting layer, is higher than that of air. For example, in an organic EL display device, the refractive index of an organic thin-film layer such as light-emitting layer is from 1.6 to 2.1. Therefore, the light emitted readily causes total reflection or interference at the interface and the light extraction efficiency is less than 20%. Thus, the majority of light is lost.

This light loss in an organic EL display device is reviewed by referring to FIG. 1.

The organic EL display device is fundamentally fabricated such that, as shown in FIG. 1, a back electrode 2, an organic layer 3 composed of two or three layers including a light-emitting layer, a transparent electrode 4 and a transparent substrate 5 are stacked on a TFT substrate 1, and a hole injected from the back electrode 2 and an electron injected from the transparent electrode 4 are recombined in the organic layer 3 to excite a fluorescent substance or the like, whereby light is emitted. The light emitted from the organic layer 3 is output from the transparent substrate 5 directly or after being reflected from the back electrode 2 formed of aluminum or the like.

However, as shown in FIG. 1 light generated inside of the display device causes total reflection depending on the angle of light incident on the interface with an adjacent layer differing in the refractive index, and the light is entirely waveguided through the inside of the display derive and cannot be extracted to the outside (light of Lb and Lc in FIG. 1) The percentage of this waveguided light is determined by the refractive index relative to the adjacent layer and in the case of a general organic EL display device (air (n=1.0)/transparent substrate (n=1.5)/transparent electrode (n=2.0)/organic layer (n=1.7)/back electrode), the percentage of light which is not released to the atmosphere (air) but is waveguided through the inside of the display devices becomes about 81%. That is, only about 19% of the entire light emission quantity cannot be effectively utilized.

Accordingly, the measures required for enhancing the light extraction efficiency are: (a) to extract light totally reflected from the transparent substrate/air interface and waveguided through the “organic layer+transparent electrode+transparent substrate” (Lb in FIG. 1); and (b) to extract light totally reflected from the transparent electrode/transparent substrate interface and waveguided through the “organic layer+transparent electrode” (Lc in FIG. 1).

Out of these measures, with respect to (a), a method of preventing total reflection from the transparent substrate/air interface by forming irregularities on the transparent substrate surface has been proposed (see, for example, U.S. Pat. No. 4,774,435).

With respect to (b), a method of processing the transparent electrode/transparent substrate interface or light-emitting layer/adjacent layer interface to have a diffraction grating has been proposed (see, for example, JP-A-11-283751 (the term “JP-A” as used herein means an “unexamined published Japanese patent application”) and JP-A-2002-313554). Also, a method of increasing the light emission efficiency by processing the interface between stacked organic layers to have irregularities has been proposed (see, for example, JP-A-2002-313567). For example, in the method of forming a diffraction grating at the light-emitting layer/adjacent layer interface, the adjacent layer comprises an electrically conductive medium, the depth of irregularities of the diffraction grating is about 40% based on the film thickness of the light-emitting layer, and the pitch and depth of irregularities are set to be in a specific relationship, whereby the waveguided light is extracted. In the method of forming irregularities at the interface between organic layers, the adjacent layers across irregularities each comprises an electrically conductive medium, and irregularities having a depth of about 20% based on the film thickness of the light-emitting layer and a tilt angle of 30° with respect to the interface are formed at the interface between organic layers to enlarge the interface at which the organic layers are joined together, whereby the light emission efficiency is increased.

However, these methods have such a problem as that the processing is difficult or dielectric breakdown readily occurs at the time of passing a current. In order to elevate the efficiency of the light-emitting display device, further development of a useful method for extracting light is demanded.

As one of the means for solving these problems, for example, a technique of providing a light scattering layer on the surface of an organic EL surface light emitter to improve the extraction efficiency has been proposed (see, for example, JP-A-2003-109747 and JP-A-2003-173877). However, occurrence of light scattering on the surface brings about a problem that light is greatly blurred and resolution deteriorates.

### SUMMARY OF THE INVENTION

Accordingly, an object of the present invention is to obtain a display device with high light extraction efficiency and less image blurring, which is a self-emission type light-emitting display device where the light emission site has a refractive index higher than the refractive index of air. In particular, an object of the present invention is to provide a scattering member capable of enhancing the extraction efficiency of light waveguided through “an organic layer+a transparent electrode”, and an organic electroluminescent display device with high light extraction efficiency.

The object of the present invention can be attained by the scattering member and organic electroluminescent display device described in (1) to (21) below.

(1) A scattering member, comprising:

a binder; and

a light scattering particle,

wherein the scattering member is used for an organic electroluminescent display device.

(2) The scattering member as described in (1) above,

wherein the binder contains a liquid.

(3) The scattering member as described in (1) above,

wherein the binder contains a self-adhesive agent.

(4) The scattering member as described in (1) above,

wherein the binder contains an adhesive.

(5) The scattering member as described in (1) above,

wherein the binder contains a light-transmitting resin.

(6) The scattering member as described in any one of (1) to (5) above,

wherein a refractive index of the binder is 1.65 or more.

(7) The scattering member as described in any one of (1) to (6) above,

wherein the binder contains at least one kind of an inorganic fine particle selected from the group consisting of ZrO₂, TiO₂, ZnO and SnO₂.

(8) The scattering member as described in any one of (1) to (7) above,

wherein a refractive index of the light scattering particle is 1.55 or less or 2.1 or more

(9) The scattering member as described in any one of (1) to (8) above,

wherein an average diameter of the light scattering particle is 2.0 μm or less.

(10) The scattering member as described in any one of (1) to (8) above,

wherein an average diameter of the light scattering particle is from 0.2 to 0.5 μm.

(11) The scattering member as described in any one of (1) to (10) above, which has a film thickness of from 0.5 to 10.0 μm.

(12) The scattering member as described in any one of (1) to (10) above, which has a film thickness of from 1.0 to 7.5 μm.

(13) The scattering member as described in any one of (1) to (5) above,

wherein a refractive index of the binder is 1.5 or less.

(14) The scattering member as described in (13) above,

wherein the binder contains at least one kind of a fine particle selected from the group consisting of a silica fine particle and a hollow silica fine particle.

(15) The scattering member as described in (13) or (14) above,

wherein a refractive index of the light scattering particle is 1.65 or more.

(16) The scattering member as described in any one of (13) to (15) above,

wherein an average diameter of the light scattering particle is 2.0 μm or less.

(17) The scattering member as described in any one of (L3) to (15) above,

wherein an average diameter of the light scattering particle is from 0.2 to 0.5 μm.

(18) The scattering member as described in any one of (13) to (17) above, which has a film thickness of from 0.5 to 10.0 μm.

(19) The scattering member as described in any one of (13) to (17) above, which has a film thickness of from 1.0 to 7.5 μm.

(20) An organic electroluminescent display device, comprising:

a substrate;

a lower electrode;

an organic electroluminescent layer;

an upper electrode; and

a transparent substrate, in this order,

wherein the scattering member as described in any one of (1) to (19) is in contact with the upper electrode.

(21) An organic electroluminescent display device, comprising;

a substrate;

a lower electrode;

an organic electroluminescent layer;

an upper electrode;

a barrier layer; and

a transparent substrate, in this order,

wherein the scattering member as described in any one of (1) to (19) is in contact with the barrier layer.

### BRIEF DESCRIPTION OF THE DRAWINGS

FIG. 1 represents a view for explaining the cause of decrease in the light extraction efficiency in a self-emission display device;

FIG. 2 represents a schematic view showing the basic construction of an organic EL display device;

FIG. 3 represents a view showing the construction when a self-adhesive agent is contained in the scattering member, which is the construction of Examples 1 and 2 of the present invention;

FIG. 4 represents a view showing the construction when an adhesive is contained in the scattering member, which is the construction of Examples 3 and 4 of the present invention; and

FIG. 5 represents a view showing the construction when a light-transmitting resin is contained in the scattering member, which is the construction of Examples 5 to 10 of the present invention,

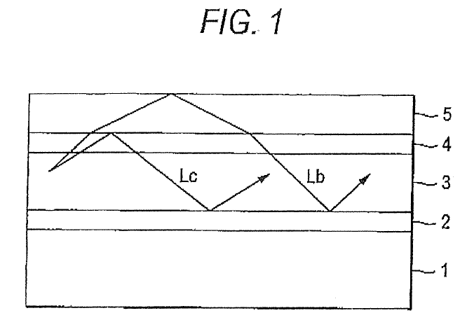

wherein 1 denotes TFT substrate; 2 denotes back electrode; 3 denotes organic layer; 4 denotes transparent electrode; 5 denotes transparent substrate; 100 denotes basic construction of organic EL display device; 101 denotes element construction of Examples 1 and 2; 102 denotes element construction of Examples 3 and 4; 103 denotes element construction of Examples 5 to 10; 110 denotes TFT substrate; 120 denotes lower electrode; 130 denotes organic EL layer; 140 denotes upper electrode; 150 denotes barrier layer; 160 denotes transparent substrate; 170 denotes scattering member; and 180 denotes laminating member.

### DETAILED DESCRIPTION OF THE INVENTION

The present invention is described in more detail below.

<<Organic Electroluminescent Display Device>>

The display device of the present invention is a display device where a light-emitting layer or a plurality of organic compound thin films including a light-emitting layer are formed between a pair of electrodes, that is, an anode and a cathode, and may have a hole injection layer, a hole transport layer, an electron injection layer, an electron transport layer, a barrier layer and the like, in addition to the light-emitting layer, and these layers each may have other functions.

The anode supplies a hole to the hole injection layer, hole transport layer, light-emitting layer or the like, and the material which can be used for the anode is a metal, an alloy, a metal oxide, an electrically conductive compound, a mixture thereof or the like, preferably a material having a work function of 4 eV or more. Specific examples thereof include an electrically conductive metal oxide such as tin oxide, zinc oxide, indium oxide and indium tin oxide (ITO), a metal such as gold, silver, chromium and nickel, a mixture or laminate of such a metal and such an electrically conductive metal oxide, an inorganic electrically conductive substance such as copper iodide and copper sulfide, an organic electrically conductive material such as polyaniline, polythiophene and polypyrrole, and a laminate of such a material with ITO. An electrically conductive metal oxide is preferred, and ITO is more preferred in view of productivity, high electrical conductivity, transparency and the like. The film thickness of the anode may be appropriately selected according to the material, but usually, the film thickness is preferably from 10 nm to 5 μm, more preferably from 50 nm to 1 μm, still more preferably from 100 to 500 nm.

The anode is usually used as a layer formed on soda lime glass, non-alkali glass, a transparent resin substrate or the like. In the case of using glass, the material thereof is preferably non-alkali glass so as to reduce ion dissolved out from the glass. In the case of using soda lime glass, this is preferably used after applying thereto a barrier coat such as silica The thickness of the substrate is not particularly limited as long as it is sufficiently large to maintain the mechanical strength, but in the case of using glass, the thickness is usually 0.2 mm or more, preferably 0.7 mm or more.

A barrier film may also be used as the transparent resin substrate. The barrier film is a film produced by providing a gas-impermeable barrier layer on a plastic support. Examples of the barrier film include those where silicon oxide or aluminum oxide is vapor-deposited (see, JP-B-53-12953 (the term “JP-B” as used herein means an “examined Japanese patent publication”) and JP-A-58-217344), an organic-inorganic hybrid coating layer is provided (see, JP-a-2000-323273 and JP-A-2004-25732), an inorganic layered compound is provided (see, JP-A-2001-205743), an inorganic material is stacked (see, JP-A-2003-206361 and JP-A-2006-263989), an organic layer and an inorganic layer are alternately stacked (see, JP-A-2007-30387, U.S. Pat. No. 6,413,645, and Affinito et al., Thin Solid Films, pp. 290-291 (1996)), or an organic layer and an inorganic layer are continuously stacked (see, U.S. Patent 2004-46497).

In the production of the anode, various methods are employed according to the material. For example, in the case of ITO, examples of the film formation method include an electron beam method, a sputtering method, a resistance heating vapor deposition method, a chemical reaction method (e.g., sol-gel method), and a method of coating an indium tin oxide dispersion. When the anode is subjected to cleaning or other treatments, this enables decreasing the driving voltage or improving the light emission efficiency of the display device For example, in the case of ITO, a UV-ozone treatment or the like is effective.

The cathode supplies an electron to the electron injection layer, electron transport layer, light-emitting layer or the like, and the material therefor is selected by taking into consideration the adhesion to a layer adjacent to the negative electrode, such as electron injection layer, electron transport layer or light-emitting layer, the ionization potential, the stability and the like. As for the cathode material, a metal, an alloy, a metal oxide, an electrically conductive compound or a mixture thereof can be used, and specific examples of the material include an alkali metal (e.g., Li, Na, K) or a fluoride thereof, an alkaline earth metal (e.g., Mg, Ca) or a fluoride thereof, gold, silver, lead, aluminum, an alloy or mixed metal of sodium and potassium, an alloy or mixed metal of lithium and aluminum, an alloy or mixed metal of magnesium and silver, and a rare earth metal such as indium and ytterbium. Among these, preferred is a material having a work function of 4 eV or less, and more preferred are aluminum, an alloy or mixed metal of lithium and aluminum, and an alloy or mixed metal of magnesium and silver. The film thickness of the cathode may be appropriately selected according to the material, but usually, the film thickness is preferably from 10 nm to 5 μm, more preferably from 50 nm to 1 μm, still more preferably from 100 nm to 1 μm. Examples of the production method of the cathode include an electron beam method, a sputtering method, a resistance heating vapor deposition method and a coating method, and a single metal component may be vapor-deposited or two or more components may be simultaneously vapor-deposited. Furthermore, an alloy electrode may also be formed by simultaneously vapor-depositing a plurality of metals, or an alloy previously prepared may be vapor-deposited.

The sheet resistance of the anode and cathode is preferably lower and is preferably several hundreds of Ω/sq or less.

The invasion of a gas can be prevented not only by laminating the above-described barrier film on the cathode but also by forming a protective layer on the display surface.

The material for the light-emitting layer may be any material as long as it can form a layer having a function of, when an electric field is applied, injecting a hole from the anode, hole injection layer or hole transport layer and at the same time, injecting an electron from the cathode, electron injection layer or electron transport layer, a function of moving the injected electric charge, or a function of providing a site for the recombination of a hole and an electron to effect light emission. Preferably, the light-emitting layer contains the compound of the present invention, but a light-emitting material other than the compound of the present invention may also be used. Examples thereof include various metal complexes as typified by a metal complex or rare earth complex of benzoxazole derivatives, benzimidazole derivatives, benzothiazole derivatives, styrylbenzene derivatives, polyphenyl derivatives, diphenylbutadiene derivatives, tetraphenylbutadiene derivatives, naphthalimide derivatives, coumarin derivatives, perylene derivatives, perynone derivatives, oxadiazole derivatives, aldazine derivatives, pyralidine derivatives, cyclopentadiene derivatives, bisstyrylanthracene derivatives, quinacridone derivatives, pyrrolopyridine derivatives, thiadiazolopyridine derivatives, cyclopentadiene derivatives, styrylamine derivatives, aromatic dimethylidine compound or 8-quinolinol derivatives; and a polymer compound such as polythiophene, polyphenylene and polyphenylenevinylene. The film thickness of the light-emitting layer is not particularly limited but usually, the thickness is preferably from 1 nm to 5 μm, more preferably from 5 nm to 1 μm, still more preferably from 10 to 500 nm.

The method for forming the light-emitting layer is not particularly limited, but examples of the method include a resistance heating vapor deposition method, an electron beam method, a sputtering method, a molecular lamination method, a coating method (e.g., spin coating, casting, dip coating) and an LB method. A resistance heating vapor deposition method and a coating method are preferred.

The material for the hole injection layer and hole transport layer may be sufficient if it has any one of a function of injecting a hole from the anode, a function of transporting a hole, and a function of blocking the electron injected from the cathode. Specific examples of the material include a carbazole derivative, a triazole derivative, an oxazole derivative, an oxadiazole derivative, an imidazole derivative, a polyarylalkane derivative, a pyrazoline derivative, a pyrazolone derivative, a phenylenediamine derivative, an arylamine derivative, an amino-substituted chalcone derivative, a styrylanthracene derivative, a fluorenone derivative, a hydrazone derivative, a stilbene derivative, a silazane derivative, an aromatic tertiary amine compound, a styrylamine compound, an aromatic dimethylidine-based compound, a porphyrin-based compound, a polysilane-based compound, a poly(N-vinylcarbazole) derivative, an aniline-based copolymer, and an electrically conductive polymer or oligomer such as thiophene oligomer and polythiophene. The film thickness of the hole injection layer and hole transport layer is not particularly limited but usually, the thickness is preferably from 1 nm to 5 μm, more preferably from 5 nm to 1 μm, still more preferably from 10 to 500 nm. The hole injection layer and the hole transport layer each may have a single-layer structure comprising one species or two or more species of the above-described materials or may have a multilayer structure comprising a plurality of layers having the same composition or different compositions.

As for the method of forming the hole injection layer and hole transport layer, a vacuum vapor deposition method, an LB method, or a method of dissolving or dispersing the above-described hole injection/transport material in a solvent and coating the obtained solution (e.g., spin coating, casting, dip coating) is used. In the case of a coating method, the material can be dissolved or dispersed together with a resin component, and examples of the resin component include polyvinyl chloride, polycarbonate, polystyrene, polymethyl methacrylate, polybutyl methacrylate, polyester, polysulfone, polyphenylene oxide, polybutadiene, poly(N-vinylcarbazole), hydrocarbon resin, ketone resin, phenoxy resin, polyamide, ethyl cellulose, vinyl acetate, ABS resin, polyurethane, melamine resin, unsaturated polyester resin, alkyd resin, epoxy resin and silicon resin.

The material for the electron injection layer and electron transport layer may be sufficient if it has any one of a function of injecting an electron from the cathode, a function of transporting an electron, and a function of blocking the hole injected from the anode. Specific examples of the material include various metal complexes as typified by a metal complex of triazole derivatives, oxazole derivatives, oxadiazole derivatives, fluorenone derivatives, anthraquinodimethane derivatives, anthrone derivatives, diphenylquinone derivatives, thiopyran dioxide derivatives, carbodiimide derivatives, fluorenylidenemethane derivatives, distyrylpyrazine derivatives, heterocyclic tetracarboxylic acid anhydride (e.g., naphthaleneperylene), phthalocyanine derivatives or 8-quinolinol derivatives, and a metal complex in which the ligand is metal phthalocyanine, benzoxazole or benzothiazole. The film thickness of the electron injection layer and electron transport layer is not particularly limited but usually, the thickness is preferably from 1 nm to 5 μm, more preferably from 5 nm to 1 μm, still more preferably from 10 to 500 nm. The electron injection layer and the electron transport layer each may have a single-layer structure comprising one species or two or more species of the above-described materials or may have a multilayer structure comprising a plurality of layers having the same composition or different compositions.

Examples of the method for forming the electron injection layer and electron transport layer include a vacuum vapor deposition method, an LB method, and a method of dissolving or dispersing the above-described electron injection/transport material in a solvent and coating the obtained solution (e.g., spin coating, casting, dip coating). In the case of a coating method, the material can be dissolved or dispersed together with a resin component, and as regards the resin component, for example, those described above for the hole injection/transport layer can be applied.

The material for the barrier layer may be sufficient if it has a function of blocking an element deterioration-accelerating material such as water and oxygen from intruding into the device. Specific examples of the material include a metal such as In, Sn, Pb, Au, Cu, Ag, Al, Ti and Ni, a metal oxide such as MgO, SiO, SiO₂, Al₂O₃, GeO, NiO, CaO, BaO, Fe₂O₃, Y₂O₃ and TiO₂, a metal nitride such as SiN₂, a metallic acid nitride such as SiON, a metal fluoride such as MgF₂, LiF, AlF₃ and CaF₂, polyethylene, polypropylene, polymethyl methacrylate, polyimide, polyurea, polytetrafluoroethylene, polychlorotrifluoroethylene, polydichlorofluoroethylene, a copolymer of chlorotrifluoroethylene and dichlorodifluoroethylene, a copolymer obtained by copolymerizing a monomer mixture containing tetrafluoroethylene and at least one comonomer, a fluorine-containing copolymer having a cyclic structure in the copolymer main chain, a water-absorbing substance having a water absorption percentage of 1% or more, and a moisture-resistant substance having a water absorption percentage of 0.1% or less.

The method for forming the barrier layer is also not particularly limited, and examples of the method which can be applied include a vacuum vapor deposition method, a sputtering method, a reactive sputtering method, an MBE (molecular beam epitaxy) method, a cluster ion beam method, an ion plating method, a plasma polymerization method (high frequency-excited ion plating method), a plasma CVD method, a laser CVD method, a heat CVD method, a gas source CVD method, and a coating method.

### <<Scattering Member>>

The scattering member comprises at least a binder and a light scattering particle. The binder and light scattering particle are described in detail below.

### <Binder>

The binder comprises at least one kind selected from the group consisting of a liquid, a self-adhesive agent, an adhesive and a light-transmitting resin. Also, in the binder, an inorganic fine particle can be mixed for adjusting the refractive index The liquid, self-adhesive agent, adhesive, light-transmitting resin and inorganic fine particle are described in detail below.

### <Liquid>

With respect to the material for the liquid as one embodiment of the binder contained in the scattering member of the present invention, a substance which is a liquid at ordinary temperature, such as water, alcohol, oil and silicone oil, can be used.

### <Self-Adhesive Agent>

The material for the self-adhesive agent as one embodiment of the binder contained in the scattering member of the present invention is preferably a pressure-sensitive self-adhesive agent such as rubber-based self-adhesive agent, acrylic self-adhesive agent, silicone-based self-adhesive agent, urethane-based self-adhesive agent, polyether-based self-adhesive agent and polyester-based self-adhesive agent.

In the case of an acrylic self-adhesive agent, various (meth)acrylic acid esters [the “(meth)acrylic acid ester” is a term collectively expressing an acrylic acid ester and a methacrylic acid ester; hereinafter, the same applies to compounds prefixed by “(meth)”] can be used as the monomer for the acrylic polymer which is the base polymer of the acrylic self-adhesive agent Specific examples of the (meth)acrylic acid ester include methyl (meth)acrylate, ethyl (meth)acrylate, butyl (meth)acrylate and 2-ethylhexyl (meth)acrylate, and these esters can be used individually or in combination Also, for imparting polarity to the obtained acrylic polymer, a (meth)acrylic acid may be used in a small amount to replace a part of the (meth)acrylic acid ester. Furthermore, a crosslinking monomer such as glycidyl (meth)acrylate, 2-hydroxyethyl (meth)acrylate and N-methylol(meth)acrylamide may also be used in combination. If desired, other copolymerizable monomers such as vinyl acetate and styrene may be further used in combination to such an extent as not impairing the self-adhesive property of the (meth)acrylic acid ester polymer.

Examples of the base polymer of the rubber-based self-adhesive agent include natural rubber, isoprene-based rubber, styrene-butadiene-based rubber, reclaimed rubber, polyisobutylene-based rubber, styrene-isoprene-styrene-based rubber and styrene-butadiene-styrene-based rubber.

Examples of the base polymer of the silicone-based self-adhesive agent include dimethylpolysiloxane and diphenylpolysiloxane.

Examples of the base polymer of the polyether-based self-adhesive agent include polyvinyl ethyl ether, polyvinyl butyl ether and polyvinyl isobutyl ether.

The self-adhesive agent may contain a crosslinking agent. Examples of the crosslinking agent include a polyisocyanate compound, a polyamine compound, a melamine resin, a urea resin and an epoxy resin. Also, a tackifier, a plasticizer, a filler, an antioxidant, an ultraviolet adsorbent and the like, which are conventionally known, may be appropriately used, if desired, in the self-adhesive agent within the range not departing from the purport of the present invention.

In addition to these materials, the self-adhesive agent may contain, for example, a monomer having a high refractive index and/or a metal oxide ultrafine particle having a high refractive index. Examples of the monomer having a high refractive index include bis(4-methacryloylthiophenyl) sulfide, vinylnaphthalene, vinylphenyl sulfide and 4-methacryloxyphenyl-4′-methoxyphenyl thioether As for the metal oxide ultrafine particle having a high refractive index, it is preferred to contain a fine particle having an average diameter of 100 nm or less, preferably an average diameter of 50 nm or less, and comprising an oxide of at least one metal selected from the group consisting of zirconium, titanium, aluminum, indium, zinc, tin and antimony. The metal oxide ultrafine particle having a high refractive index is preferably an oxide ultrafine particle of at least one metal selected from the group consisting of Al, Zr, Zn, Ti, In and Sn, and specific examples thereof include ZrO₂, TiO₂, Al₂O₃, In₂O₃, ZnO, SnO₂, Sb₂O₃ and ITO. Among these, ZrO₂ is more preferred. The amount of the monomer or metal oxide ultrafine particle having a high refractive index added is preferably from 10 to 90 mass %, more preferably from 20 to 80 mass %, based on the total mass of the self-adhesive agent. (In this specification, mass ratio is equal to weight ratio.)

Furthermore, in addition to these materials, the self-adhesive agent may contain an ultrafine particle or the like having a low refractive index. As for the ultrafine particle having a low refractive index, it is preferred to contain a silica fine particle having an average diameter of 100 nm or less, preferably an average diameter of 50 nm or less. Also, a hollow silica containing air in the particle and expressing a lower refractive index may be used. The amount of the ultrafine particle having a low refractive index added is preferably from 10 to 90 mass %, more preferably from 20 to 80 mass %, based on the total mass of the adhesive.

The amount of the light scattering particle added is preferably from 1 to 40 parts by mass, because if the amount added is less than 1 part by mass, light diffusibility is insufficient, whereas if it exceeds 40 parts by mass, the self-adhesive force tends to slightly decrease.

The method for forming a self-adhesive agent layer in an organic EL light-emitting device is not particularly limited and includes conventionally known methods such as a method of coating a self-adhesive agent solution on an organic EL light-emitting device and drying the coating, and a method of transferring the layer from a release sheet having provided thereon the self-adhesive agent layer. The thickness of the self-adhesive agent layer is not particularly limited but is, in terms of the dry thickness, preferably from 0.1 to 40.0 μm, more preferably from 0.5 to 10.0 μm, and most preferably from 1.0 to 7.5 μm.

### <Adhesive>

The adhesive as one embodiment of the binder contained in the scattering member of the present invention is described in detail below The adhesive is preferably an adhesive which flows under heating or under pressure, more preferably an adhesive which exhibits flowability under heating at 200° C. or less or under pressure of 1 kgf/cm² or more. By using such an adhesive, a member such as transparent substrate can be adhered to an adherend, that is, a display or plastic plate, by fluidizing the adhesive. The adhesive can be fluidized, so that an optical film can be easily adhered to an adherend by lamination or pressing, particularly pressing, or even to an adherend having a curved surface or a complicated shape. To this end, the softening temperature of the adhesive is preferably 200° C. or less.

As for the adhesive which flows under heating or under pressure, the following thermoplastic resins are mainly representative thereof Examples of the adhesive which can be used include natural rubber (refractive index n=1.52), (di)enes such as polyisoprene (n=1.521), poly-1,2-butadiene (n=1.50), polyisobutene (n-1.505 to 1.51), polybutene (n=1.513), poly-2-heptyl-1,3-butadiene (n=1.50), poly-2-tert-butyl-1,3-butadiene (n=1.506) and poly-1, 3-butadiene (n=1.515), polyethers such as polyoxyethylene (n=1.456), polyoxypropylene (n=1.450), polyvinyl ethyl ether (n=1.454), polyvinyl hexyl ether (n=1.459) and polyvinyl butyl ether (n=1.456), polyesters such as polyvinyl acetate (n=1.467) and polyvinyl propionate (n=1.467), polyurethane (n=1.5 to 1.6), ethyl cellulose (n=1.479), polyvinyl chloride (n=1.54 to 1.55), polyacrylonitrile (n=1.52), polymethacrylonitrile (n=1.52), polysulfone (n=1.633), polysulfide (n=1.6), phenoxy resin (n=1.5 to 1.6), and poly(meth)acrylic acid esters such as polyethyl acrylate (n=1.469), polybutyl acrylate (n=1.466), poly-2-ethylhexyl acrylate (n=1.463), poly-tert-butyl acrylate (n=1.464), poly-3-ethoxypropyl acrylate (n=1.465), polyoxycarbonyl tetramethylene (n-1.465), polymethyl acrylate (n=1.472 to 1.480), polyisopropyl methacrylate (n=1.473), polydodecyl methacrylate (n=1.474), polytetradecyl methacrylate (n=1.475), poly-n-propyl methacrylate (n=1.484), poly-3,3,5-trimethylcyclohexyl methacrylate (n=1.484), polyethyl methacrylate (n=1.485), poly-2-nitro-2-methylpropyl methacrylate (n=1.487), poly-1,1-diethylpropyl methacrylate (n=1.489) and polymethyl methacrylate (n=1.489). Two or more of these acrylic polymers may be copolymerized or blended, if desired. Furthermore, a copolymerized resin of an acrylic resin with a polymer other than acryl, such as epoxy acrylate (n=1.48 to 1.60), urethane acrylate (n=1.5 to 1.6), polyether acrylate (n=1.48 to 1.49) and polyester acrylate (n=1.48 to 1.54), may also be used. Above all, urethane acrylate, epoxy acrylate and polyether acrylate are excellent in view of adhesive property. Examples of the epoxy acrylate include (meth)acrylic acid adducts of 1,6-hexanediol diglycidyl ether, neopentyl glycol diglycidyl ether, allyl alcohol diglycidyl ether, resorcinol diglycidyl ether, adipic acid diglycidyl ester, phthalic acid diglycidyl ester, polyethylene glycol diglycidyl ether, trimethylolpropane triglycidyl ether, glycerin triglycidyl ether, pentaerythritol tetraglycidyl ether, and sorbitol tetraglycidyl ether. A polymer having a hydroxyl group within its molecule, such as epoxy acrylate, is effective in enhancing the adhesive property. Two or more of these copolymerized resins may be used in combination, if desired The softening point of the polymer becoming an adhesive is, in view of handleability, preferably 200° C. or less, more preferably 150° C. or less. Considering usage of the light diffusing film, the use environment is usually at 80° C. or less and therefore, the softening temperature of the adhesive layer is most preferably from 80 to 120° C. in view of processability. On the other hand, the mass average molecular weight (a mass average molecular weight measured using a calibration curve of standard polystyrene by gel permeation chromatography; hereinafter the same) of the polymer used is preferably 500 or more. If the molecular weight is less than 500, the cohesive force of the adhesive composition is too low and the adhesion to an adherend may decrease. In the adhesive for use in the present invention, additives such as diluent, plasticizer, antioxidant, filler, colorant, ultraviolet absorbent and tackifier may be blended, if desired. The thickness of the adhesive layer is preferably from 1 to 50 μm, more preferably from 1 to 20 μm.

As for the material of the adhesive, bisphenol A-type epoxy resin, bisphenol F-type epoxy resin, tetrahydroxy-phenylmethane-type epoxy resin, novolak-type epoxy resin, resorcin-type epoxy resin, polyalcohol polyglycol-type epoxy resin, polyolefin-type epoxy resin, and epoxy resin such as alicyclic or halogenated bisphenol, may be used (all have a refractive index of 1.55 to 1.60). Examples of the material other than epoxy resin include natural rubber (n=1.52), (di)enes such as polyisoprene (n=1.521), poly-1,2-butadiene (n=1.50), polyisobutene (n=1.505 to 1.51), polybutene (n=1.5125), poly-2-heptyl-1,3-butadiene (n=1.50), poly-2-tert-butyl-1,3-butadiene (n=1.506) and poly-1,3-butadiene (n=1.515), polyethers such as polyoxyethylene (n=1.4563), polyoxypropylene (n=1.4495), polyvinyl ethyl ether (n=1.454), polyvinyl hexyl ether (n=1.4591) and polyvinyl butyl ether (n=1.4563), polyesters such as polyvinyl acetate (n=1.4665) and polyvinyl propionate (n=1.4665), polyurethane (n=1.5 to 1.6), ethyl cellulose (n=1.479), polyvinyl chloride (n=1.54 to 1.55), polyacrylonitrile (n=1.52), polymethacrylonitrile (n=1.52), polysulfone (n=1.633), polysulfide (n=1.6), and phenoxy resin (n=1.5 to 1.6). These materials have a suitable visible light transmittance.

Other than these resins, there may be used poly(meth)acrylic acid esters such as polyethyl acrylate (n=1.4685), polybutyl acrylate (n=1.466), poly-2-ethylhexyl acrylate (n=1.463), poly-tert-butyl acrylate (n=1.4638), poly-3-ethoxypropyl acrylate (n=1.465), polyoxycarbonyl tetramethacrylate (n=1.465), polymethyl acrylate (n=1.472 to 1.480), polyisopropyl methacrylate (n=1.4728), poly-dodecyl methacrylate (n=1.474), polytetradecyl methacrylate (n=1.4746), poly-n-propyl methacrylate (n=1.484), poly-3,3,5-trimethylcyclohexyl methacrylate (n=1.484), polyethyl methacrylate (n=1.485), poly-2-nitro-2-methylpropyl methacrylate (n=1.4868), polytetracarbanyl methacrylate (n=14889), poly-1,1-diethylpropyl methacrylate (n=1.4889) and polymethyl methacrylate (n=1.4893). Two or more of these acrylic polymers may be copolymerized or blended, if desired.

Furthermore, a copolymerized resin of an acrylic resin with a polymer other than acryl, such as epoxy acrylate, urethane acrylate, polyether acrylate and polyester acrylate, may also be used. Above all, epoxy acrylate and polyether acrylate are excellent in view of adhesive property. Examples of the epoxy acrylate include (meth)acrylic acid adducts of 1,6-hexanediol diglycidyl ether, neopentyl glycol diglycidyl ether, allyl alcohol diglycidyl ether, resorcinol diglycidyl ether, adipic acid diglycidyl ester, phthalic acid diglycidyl ester, polyethylene glycol diglycidyl ether, trimethylolpropane triglycidyl ether, glycerin triglycidyl ether, pentaerythritol tetraglycidyl ether, and sorbitol tetraglycidyl ether. The epoxy acrylate has a hydroxyl group within its molecule and therefore, is effective in enhancing the adhesive property. Two or more of these copolymerized resins may be used in combination, if desired. The mass average molecular weight of the polymer used to become the main component of the adhesive is 1,000 or more If the molecular weight is less than 1,000, the cohesive force of the composition is too low and the adhesion to an adherend decreases.

In addition to these materials, the adhesive may contain, for example, a monomer having a high refractive index and/or a metal oxide ultrafine particle having a high refractive index. Examples of the monomer having a high refractive index include bis(4-methacryloylthiophenyl) sulfide, vinylnaphthalene, vinylphenyl sulfide and 4-methacryloxyphenyl-4′-methoxyphenyl thioether. As for the metal oxide ultrafine particle having a high refractive index, it is preferred to contain a fine particle having an average diameter of 100 nm or less, preferably an average diameter of 50 nm or less, and comprising an oxide of at least one metal selected from the group consisting of zirconium, titanium, aluminum, indium, zinc, tin and antimony. The metal oxide ultrafine particle having a high refractive index is preferably an oxide ultrafine particle of at least one metal selected from the group consisting of Al, Zr, Zn, Ti, In and Sn, and specific examples thereof include ZrO₂, TiO₂, Al₂O₃, In₂O₃, ZnO, SnO₂, Sb₂O₃ and ITO. Among these, ZrO₂ is preferred. The amount of the monomer or metal oxide ultrafine particle having a high refractive index added is preferably from 10 to 90 mass %, more preferably from 20 to 80 mass %, based on the total mass of the adhesive.

Furthermore, in addition to these materials, the adhesive may contain, for example, an ultrafine particle having a low refractive index. As for the ultrafine particle having a low refractive index, it is preferred to contain a silica fine particle having an average diameter of 100 nm or less, preferably an average diameter of 50 nm or less. Also, a hollow silica containing air in the particle and expressing a lower refractive index may be used The amount of the ultrafine particle having a low refractive index added is preferably from 10 to 90 mass %, more preferably from 20 to 80 mass %, based on the total mass of the adhesive.

A curing agent (crosslinking agent) may also be used in the adhesive, and examples of the crosslinking agent which can be used include amines such as triethylenetetramine, xylenediamine and diaminodiphenylmethane, acid anhydrides such as phthalic anhydride, maleic anhydride, dodecyl succinic anhydride, pyromellitic anhydride and benzophenonetetracarboxylic anhydride, diaminodiphenylsulfone, tris(dimethylaminomethyl)phenol, polyamide resin, dicyandiamide, and ethylmethylimidazole. One of these crosslinking agents may be used alone, or two or more thereof may be used as a mixture. The amount of the crosslinking agent added is preferably selected from the range of 0.1 to 50 parts by mass, preferably 1 to 30 parts by mass, per 100 parts by mass of the above-described polymer. If the amount added is less than 0.1 parts by mass, the curing becomes insufficient, whereas if it exceeds 50 parts by mass, excessive crosslinking results and adversely affects the adhesive property. In the resin composition of the adhesive for use in the present invention, additives such as diluent, plasticizer, antioxidant, filler, colorant and tackifier may be blended, if desired. The resin composition of the adhesive is coated to partially or entirely cover the substrate of a constituent material where a geometric pattern drawn with an electrically conductive material is provided on the surface of a transparent plastic substrate, and through drying of the solvent and curing under heating, the adhesive film according to the present invention is obtained. This adhesive film having electromagnetic wave shielding property and transparency is directly laminated to a display such as CRT, PDP, liquid crystal and EL by the adhesive of the adhesive film, or laminated to a plate or sheet such as acrylic plate or glass plate and then used for a display.

The adhesive for use in the present invention is preferably colorless so as not to change the display color inherent in the display. However, even if the resin itself is colored, when the thickness of the adhesive is thin, the adhesive can he regarded as being substantially colorless. Also, for the purpose of absorbing ultraviolet or infrared rays, a material capable of absorbing light in the relevant wavelength region may be mixed.

Examples of the adhesive having the above-described properties include an acrylic resin, an a-olefin resin, a vinyl acetate-based resin, an acrylic copolymer-based resin, a urethane-based resin, an epoxy-based resin, a vinylidene chloride-based resin, a vinyl chloride-based resin, an ethylene-vinyl acetate-based resin, a polyamide-based resin and a polyester-based resin. Among these, an acrylic resin is preferred. Even when the same resin is used, the self adhesive property can be enhanced by such a method as that, at the synthesis of the adhesive by a polymerization method, the amount of the crosslinking agent added is decreased, a tackifier is added, or the terminal group of the molecule is changed. Also, even with the use of the same adhesive, the adhesion can be enhanced by modifying the surface to which the adhesive is adhered, that is, by applying surface modification to the transparent plastic film or glass plate. Examples of the surface modification method include a physical method such as corona discharge treatment and plasma glow treatment, and a method of forming an underlayer for enhancing the adhesion.

The amount of the light scattering particle added is preferably from 1 to 40 parts by mass, because if the amount added is less than 1 part by mass, light diffusibility is insufficient, whereas if it exceeds 40 parts by mass, the adhesive force tends to slightly decrease.

The method for forming an adhesive layer in an organic EL light-emitting device is not particularly limited and includes conventionally known methods such as a method of coating an adhesive solution on an organic EL light-emitting device and drying the coating. The thickness of the adhesive layer is not particularly limited but is, in terms of the dry thickness, preferably on the order of 0.1 to 40.0 μm, more preferably on the order of 0.5 to 10.0 μm, and most preferably from 1.0 to 7.5 μm.

### <Light-Transmitting Resin>

As for the light-transmitting resin, resins which are cured by any of ultraviolet rays, electron beams and heat are mainly used. More specifically, three kinds of resins, that is, a photo-curable resin, an ionizing radiation-curable resin and a heat-curable resin, are used. In addition, as for these curable resins, the mixture of a thermoplastic resin and a solvent is used.

The light-transmitting resin is preferably a polymer having a saturated hydrocarbon or a polyether as the main chain, more preferably a polymer having a saturated hydrocarbon as the main chain. Also, the light-transmitting resin is preferably crosslinked. The polymer having a saturated hydrocarbon as the main chain is preferably obtained by a polymerization reaction of an ethylenically unsaturated monomer. In order to obtain a crosslinked binder, a monomer having two or more ethylenically unsaturated groups is preferably used as a material.

Examples of the monomer having two or more ethylenically unsaturated groups include an ester of polyhydric alcohol and (meth)acrylic acid (e.g., ethylene glycol di(meth)acrylate, 1,4-dichlohexane diacrylate, pentaerythritol tetra(meth)acrylate, pentaerythritol tri(meth)acrylate, trimethylolpropane tri(meth)acrylate, trimethylolethane tri(meth)acrylate, dipentaerythritol tetra(meth)acrylate, dipentaerythritol penta(meth)acrylate, dipentaerythritol hexa(meth)acrylate, 1,3,5-cyclohexanetriol trimethacrylate, polyurethane polyacrylate, polyester polyacrylate), a vinyl benzene derivative (e.g., 1,4-diviylbenzene. 4-vinylbenzoic acid-2-acryloylethyl ester, 1,4-divinylcyclohexanone), a vinylsulfone (e.g., divinylsulfone), an acrylamide (e.g., methylenebisacrylamide), and a methacrylamide. Among these, an acrylate or methacrylate monomer having at least three functional groups is preferred, and an acrylate monomer having at least five functional groups is more preferred in view of film hardness, that is, scratch resistance. A mixture of dipentaerythritol pentaacrylate and dipentaerythritol hexaacrylate is commercially available and is particularly preferred.

The monomer having an ethylenically unsaturated group is dissolved in a solvent together with a polymerization initiator of various types and other additives and after coating and drying, subjected to a polymerization reaction under the effect of ultraviolet rays, ionizing radiation or heat, whereby the coating can be cured.

A crosslinked structure may be introduced into the matrix by the reaction of a crosslinking group, in place of or in addition to the polymerization of a monomer having two or more ethylenically unsaturated groups. Examples of the crosslinking functional group include an isocyanate group, an epoxy group, an aziridine group, an oxazoline group, an aldehyde group, a carbonyl group, a hydrazine group, a carboxyl group, a methylol group and an active methylene group. Also, a vinylsulfonic acid, an acid anhydride, a cyanoacrylate derivative, melamine, an etherified methylol, an ester, or a metal alkoxide such as urethane and tetramethoxysilane, may be used as a monomer for introducing a crosslinked structure. A functional group which exhibits the crosslinking property as a result of the decomposition reaction, such as blocked isocyanate group, may also be used. That is, the crosslinking functional group for use in the present invention is not limited to a functional group which directly causes a reaction but may be a group which exhibits reactivity after the decomposition. The matrix having such a crosslinking functional group is coated and then heated, whereby a crosslinked structure can be formed.

In the light-transmitting resin, a monomer having a high refractive index may be added, in addition to the above-described matrix polymer. Examples of the monomer having a high refractive index include bis(4-methacryloylthiophenyl)sulfide, vinylnaphthalene, vinylphenyl sulfide and 4-methacryloxyphenyl-4′-methoxyphenylthioether.

Examples of the solvent include ethers having a carbon number of 3 to 12, specifically, dibutyl ether, dimethoxymethane, dimethoxyethane, diethoxyethane, propylene oxide, 1,4-dioxane, 1,3-dioxolan, 1,3,5-trioxane, tetrahydrofuran, anisole and phenetol; ketones having a carbon number of 3 to 12, specifically, acetone, methyl ethyl ketone, diethyl ketone, dipropyl ketone, diisobutyl ketone, cyclopentanone, cyclohexanone, methyl cyclohexanone and methyl cyclohexanone; esters having a carbon number of 3 to 12, specifically, ethyl formate, propyl format, n-pentyl formate, methyl acetate, ethyl acetate, methyl propionate, ethyl propionate, n-pentyl acetate and γ-butyrolactone, and an organic solvent having two or more functional groups, specifically, methyl 2-methoxyacetate, methyl 2-ethoxyacetate, methyl 2-ethoxyacetate, ethyl 2-ethoxypropionate, 2-methoxyethanol, 2-propoxyethanol, 2-butoxyethanol, 1,2-diacetoxyacetone, acetylacetone, diacetone alcohol, methyl acetoacetate and ethyl acetoacetate. Other examples of the solvent include methanol, ethanol, 1-propanol, 2-propanol, 1-butanol, 2-butanol, tert-butanol, 1-pentanol, 2-methyl-2-butanol, cyclohexanol, isobutyl acetate, methyl isobutyl ketone, 2-octanone, 2-pentanone, 2-hexanone, 2-heptanone, 3-pentanone, 3-heptanone and 4-heptanone. One of these solvents may be used alone, or two or more thereof may be used in combination.

The material for forming the light-transmitting resin is coated on the barrier layer or upper electrode of an organic EL display by a bar coater or a spin coater.

As for the method of curing the ionizing radiation-curable resin composition, a normal curing method for ionizing radiation-curable resin compositions, that is, curing by irradiation with electron beam or ultraviolet ray, may be used.

For example, in the case of electron beam curing, an electron beam having an energy of 50 to 1,000 KeV, preferably from 100 to 300 KeV, emitted from various electron beam accelerators such as Cockroft-Walton type, Van de Graff type, resonance transformer type, insulating core transformer type, linear type, Dynamitron type and high-frequency type may be used, and in the case of ultraviolet ray curing, an ultraviolet ray emitted from light of an ultrahigh pressure mercury lamp, a high pressure mercury lamp, a low pressure mercury lamp, carbon arc, xenon arc, a metal halide lamp or the like may be used.

The thickness of the scattering member using the light-transmitting resin as the binder is preferably from 0.1 to 40.0 μm, more preferably from 0. 5 to 10.0 μm, and most preferably from 1.0 to 7.5 μm.

### <Inorganic Fine Particle>

In addition to such a material, the light-transmitting resin may contain a metal oxide ultrafine particle or the like having a high refractive index. As for the metal oxide ultrafine particle having a high refractive index, it is preferred to contain a fine particle having an average diameter of 100 nm or less, preferably an average diameter of 50 nm or less, and comprising an oxide of at least one metal selected from the group consisting of zirconium, titanium, aluminum, indium, zinc, tin and antimony. The metal oxide ultrafine particle having a high refractive index is preferably an oxide ultrafine particle of at least one metal selected from the group consisting of Al, Zr, Zn, Ti, In and Sn, and specific examples thereof include ZrO₂, TiO₂, Al₂O₃, In₂O₃, ZnO, SnO₂, Sb₂O₃ and ITO. Among these, ZrO₂ is preferred. The amount of the metal oxide ultrafine particle having a high refractive index added is preferably from 10 to 90 mass %, more preferably from 20 to 80 mass %, based on the total mass of the self-adhesive agent.

In addition to these materials, the light-transmitting resin may contain an ultrafine particle or the like having a low refractive index. As for the ultrafine particle having a low refractive index, it is preferred to contain a silica fine particle having an average diameter of 100 nm or less, preferably an average diameter of 50 nm or less. Also, a hollow silica containing air in the particle and expressing a lower refractive index may be used. The amount of the ultrafine particle having a low refractive index added is preferably from 10 to 90 mass %, more preferably from 20 to 80 mass %, based on the total mass of the adhesive.

### <Light Scattering Particle>

The light scattering particle constituting the scattering member is not limited in its kind and may be an organic fine particle or an inorganic fine particle. Examples of the organic fine particle include a polymethyl methacrylate bead, an acryl-styrene copolymer bead, a melamine bead, a polycarbonate bead, a styrene bead, a crosslinked polystyrene bead, a polyvinyl chloride bead, and a benzoguanamine-melamine formaldehyde bead. Examples of the inorganic fine particle include SiO₂, ZrO₂, TiO₂, Al₂O₃, In₂O₃, ZnO, SnO₂ and Sb₂O₃. The average diameter of the inorganic fine particle is from 0.1 to 10 μm, preferably from 0.1 to 5.0 μm, and more preferably from 0.2 to 0.5 μm.

### EXAMPLES

### <<Production of Multicolor Organic EL Display Device>>

The top-emission type organic EL display device of the present invention is described below.

First, TFT is formed on an insulating substrate through a buffer layer. Next, an interlayer insulating film layer comprising an SiN film is deposited on the entire surface, and contact holes reaching the source region and drain region, respectively, are formed using a normal photoetching process.

Subsequently, an electrically conductive layer having an Al/Ti/Al multilayer structure is deposited on the entire surface and then patterned using a normal photoetching process, whereby a source electrode is formed to extend also over the TFT part and at the same time, a drain electrode is formed.

Incidentally, the source electrode is branched into four branch lines from a common source line.

Thereafter, a photosensitive resin is coated on the entire surface by using, for example, a spin coating method to form an interlayer insulating film, and the interlayer insulating film is exposed through a predetermined mask and then developed with a predetermined developer, whereby contact holes corresponding to the branch lines of the source electrode are formed.

In the Figure, for the sake of convenience, a contact hole is formed in correspondence to the common source line Furthermore, an Al film is deposited on the entire surface, for example, by a sputtering method and then patterned into a predetermined configuration by using a normal photoetching process, whereby a divided lower electrode connecting to the branch line of the source electrode through a contact hole is formed.

Subsequently, an organic EL layer covering the divided lower electrode exposed to the bottom of a pixel opening is formed by a mask vapor-deposition method, and an Al film having a thickness of, for example, 10 nm and an ITO film having a thickness of, for example, 30 nm, covering the organic EL layer, are sequentially deposited again using the mask vapor-deposition method to form a common upper electrode, where the regions corresponding to respective divided lower electrodes each becomes a divided pixel part.

Thereafter, an SiN film and an SiON film were sequentially deposited on the entire surface by a CVD method to form a barrier layer of 5 μm in thickness, and a glass plate as a transparent substrate is further laminated to the barrier layer.

FIG. 2 shows a simplified basic construction of an organic EL element 100. A lower electrode 120 is formed on a TFT substrate 110, and an organic EL layer 130, an upper electrode 140, a barrier layer 150 and a transparent substrate 160 are sequentially formed thereon.

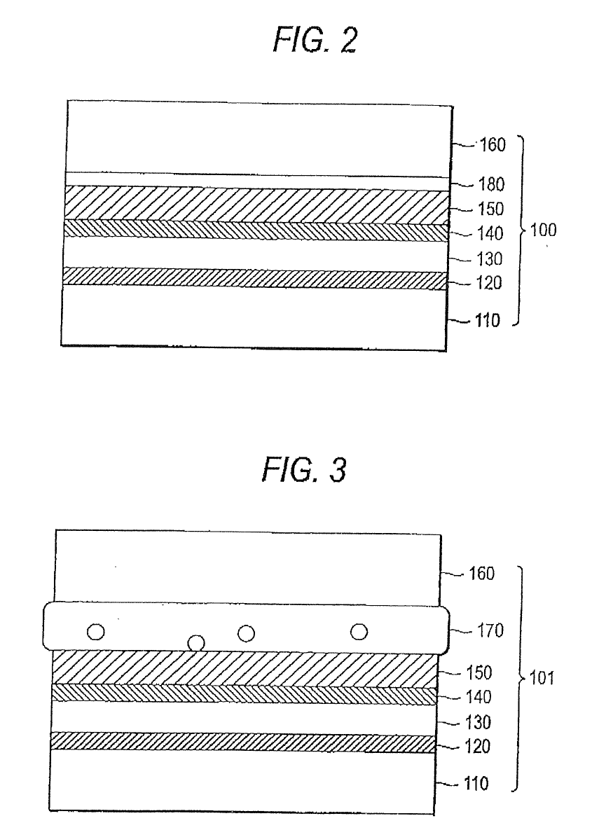

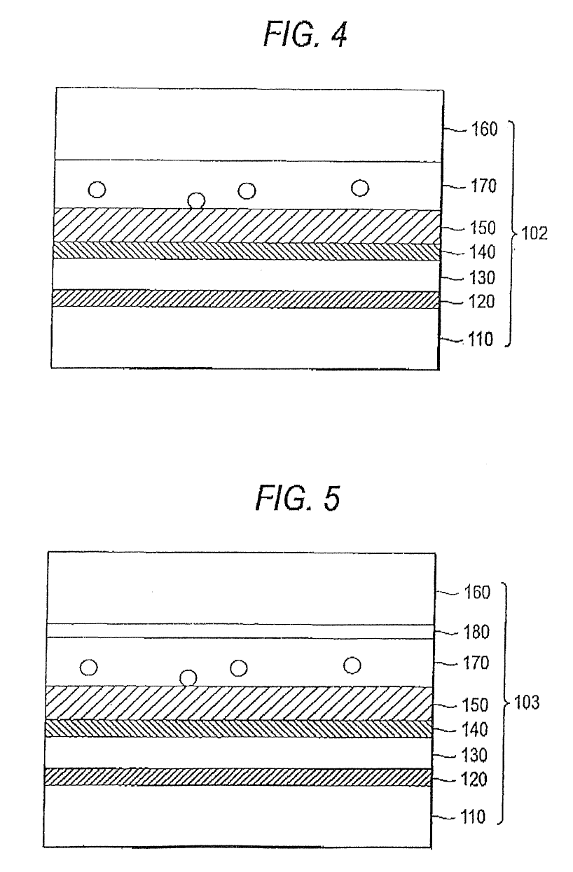

Also, FIG. 3 shows a construction of the organic EL element 101 according to the present invention. A lower electrode 120 is formed on a TFT substrate 110, and an organic EL layer 130, an upper electrode 140, a barrier layer 150, a scattering member 170 and a transparent substrate 160 are sequentially formed thereon.

### <<Production of Scattering Member>>

<Scattering Member in which Binder Contains Self-Adhesive Agent>

In Examples 1 and 2, scattering members were produced in accordance with the following blending ratios.

### Example 1

30 Parts by mass of water and 0.1 parts by mass of ammonium persulfate were charged into a four-neck flask equipped with a stirrer, a reflux condenser, a thermometer and a nitrogen blow line and after temperature was elevated to 70° C. under nitrogen purging, an emulsified monomer mixture A having the following composition was added dropwise over 4 hours After the completion of dropwise addition, the reaction was further allowed to proceed for 3 hours, whereby an acrylic copolymer emulsion having a sold content of 50% was obtained.

Composition of Emulsified Monomer Mixture A

| | | |
|---|---|---|
| n-Butyl acrylate | 49.5 | parts by mass |
| 2-Ethylhexyl acrylate | 50 | parts by mass |
| Acrylic acid | 0.5 | parts by mass |
| Water | 70 | parts by mass |
| Dodecylmercaptan | 0.05 | parts by mass |
| Sodium laurylsulfate | 0.5 | parts by mass |
| Nonionic emulsifier (“NOIGEN | 1.0 | part by mass |
| EA140”, trade name, produced | | |
| by Dai-ichi Kogyo Seiyaku | | |
| Co., Ltd.) | | |
| Inorganic Fine Particle: ZrO₂ | 100.0 | part by mass |
| filler (average diameter: 20 nm, | | |
| refractive index: 2.18) | | |
| Light scattering particle: | 17 | parts by mass |
| polymethyl methacrylate-based | | |
| bead (MX150, produced by | | |
| Soken Chemical & Engineering | | |
| Co., Ltd., average diameter: | | |
| 1.5 μm, refractive index: | | |
| 1.49) | | |
| Dispersant (“NEOGEN P”, trade | 0.1 | part by mass |
| name, produced by Dai-ichi | | |
| Kogyo Seiyaku Co., Ltd.) | | |
| Defoaming agent (“SN- | 0.1 | part by mass |
| Defoamer”, trade name, | | |
| produced by San Nopco | | |
| Limited) | | |

Here, the above preparation not containing a light scattering particle corresponds to a self-adhesive agent This self-adhesive agent is used as a binder for a scattering member. In order to measure the refractive index of this self-adhesive agent, an emulsified monomer mixture A′ in which polymethyl methacrylate-based bead was not mixed was prepared, and this was subjected to the dropwise addition and the reaction in the same way as described above, whereby an acrylic copolymer emulsion was produced. This emulsion was coated on a glass substrate to form a film of the self-adhesive agent. The refractive index of the film was measured by spectral reflectance film thickness meter, whereby the refractive index of the formed film was found to be 1.70.

### Example 2

Parts by mass of water and 0.1 parts by mass of ammonium persulfate were charged into a four-neck flask equipped with a stirrer, a reflux condenser, a thermometer and a nitrogen blow line and after temperature was elevated to 70° C. under nitrogen purging, an emulsified monomer mixture B having the following composition was added dropwise over 4 hours. After the completion of dropwise addition, the reaction was further allowed to proceed for 3 hours, whereby an acrylic copolymer emulsion having a sold content of 50% was obtained.

Composition of Emulsified Monomer Mixture B

| | | |
|---|---|---|
| n-Butyl acrylate | 49.5 | parts by mass |
| 2-Ethylhexyl acrylate | 50 | parts by mass |
| Acrylic acid | 0.5 | parts by mass |
| Water | 70 | parts by mass |
| Dodecylmercaptan | 0.05 | parts by mass |
| Sodium laurylsulfate | 0.5 | parts by mass |
| Nonionic emulsifier (“NOIGEN | 1.0 | part by mass |
| EA140”, trade name, produced | | |
| by Dai-ichi Kogyo Seiyaku | | |
| Co., Ltd.) | | |
| Inorganic Fine Particle: SiO₂ | 100.0 | part by mass |
| filler (average diameter: 15 nm, | | |
| refractive index: 1.45) | | |
| Light scattering particle: | 17 | parts by mass |
| benzoguanamine-based bead | | |
| (EPOSTAR MS, produced by | | |
| Nippon Shokubai Co., Ltd., | | |
| average diameter: 1.0 μm, | | |
| refractive index: 1.66) | | |
| Dispersant (“NEOGEN P”, trade | 0.1 | part by mass |
| name, produced by Dai-ichi | | |
| Kogyo Seiyaku Co., Ltd.) | | |
| Defoaming agent (“SN- | 0.1 | part by mass |
| Defoamer”, trade name, | | |
| produced by San Nopco | | |
| Limited) | | |

Here, the above preparation not containing a light scattering particle corresponds to a self-adhesive agent. This self-adhesive agent is used as a binder for a scattering member. In order to measure the refractive index of this self-adhesive agent, an emulsified monomer mixture B′ in which benzoguanamine-based bead was not mixed was prepared, and this was subjected to the dropwise addition and the reaction in the same way as described above, whereby an acrylic copolymer emulsion was produced. This emulsion was coated on a glass substrate to form a film of the self-adhesive agent. The refractive index of the film was measured by spectral reflectance film thickness meter, whereby the refractive index of the formed film was found to be 1.45.

The scattering member obtained was coated on the barrier layer of the organic EL display device produced above to have a thickness of 10 μm, and a transparent substrate was adhered further thereon.

<Scattering Member in which Binder Contains Adhesive>

In Examples 3 and 4, scattering members were produced in accordance with the following blending ratios.

### Example 3

| | | |
|---|---|---|
| Alicyclic epoxy resin: | 100 | parts by mass |
| CELLOXIDE 2081 (produced by | | |
| Daicel Chemical Industries, | | |
| Ltd.) | | |
| 2-Ethyl-4-methylimidazole | 4 | parts by mass |
| (produced by Shikoku Corp.) | | |
| 2,4-Diamino-6-vinyl-s- | 10 | parts by mass |
| triazine isocyanuric acid | | |
| adduct | | |
| Inorganic Fine Particle: ZrO₂ | 100 | parts by mass |
| Filler (average diameter: 20 nm, | | |
| refractive index: 2.18) | | |
| Light Scattering Particle: | 17 | parts by mass |
| Polymethyl methacrylate-based | | |
| bead (MX150, produced by | | |
| Soken Chemical & Engineering | | |
| Co., Ltd., average diameter: | | |
| 1.5 μm, refractive index: | | |
| 1.49) | | |

Here, the above preparation not containing a light scattering particle corresponds to an adhesive. This adhesive is used as a binder for a scattering member. In order to measure the refractive index of this adhesive, a mixture in which polymethyl methacrylate-based bead was omitted from the blending of Example 3 was prepared to produce an adhesive. This adhesive was coated and cured on a glass substrate to form a film of the adhesive. The refractive index of the film was measured by spectral reflectance film thickness meter, whereby the refractive index of the formed film was found to be 1.70.

### Example 4

| | | |
|---|---|---|
| Alicyclic epoxy resin: | 100 | parts by mass |
| CELLOXIDE 2081 (produced by | | |
| Daicel Chemical Industries, | | |
| Ltd.) | | |
| 2-Ethyl-4-methylimidazole | 4 | parts by mass |
| (produced by Shikoku Corp.) | | |
| 2,4-Diamino-6-vinyl-s- | 10 | parts by mass |
| triazine isocyanuric acid | | |
| adduct | | |
| Inorganic Fine Particle: SiO₂ | 100 | parts by mass |
| Filler (average diameter: 15 nm, | | |
| refractive index: 1.45) | | |
| Light Scattering Particle: | 17 | parts by mass |
| Benzoguanamine-based bead | | |
| (EPOSTAR MS, produced by | | |
| Nippon Shokubai Co., Ltd., | | |
| average diameter: 1.0 μm, | | |
| refractive index: 1.66) | | |

Here, the above preparation not containing a light scattering particle corresponds to an adhesive. This adhesive is used as a binder for a scattering member. In order to measure the refractive index of this adhesive, a mixture in which benzoguanamine-based bead was omitted from the blending of Example 4 was prepared to produce an adhesive. This adhesive was coated and cured on a glass substrate to form a film of the adhesive. The refractive index of the film was measured by spectral reflectance film thickness meter, whereby the refractive index of the formed film was found to be 1.45.

The obtained adhesive was coated on the barrier layer of the organic EL display device produced above to have a thickness of 10 μm, and a transparent substrate was further laminated thereto.

<Scattering Member in which Binder Contains Light-Transmitting Resin>

In Example 5, a scattering member where the binder is a light-transmitting resin and a light scattering particle is TiO₂ was produced in accordance with the following blending ratio.

### Example 5

### Coating Solution for Scattering Member

100 Parts by mass of zirconium oxide ultrafine particle (inorganic fine particle) dispersion-containing hardcoat coating solution (DESOLITE KZ-7114A, produced by JSR) and 57 parts by mass of a polymerizable monomer (polymerizable compound) which is a material of light-transmitting resin (DPHA, produced by Nippon Kayaku Co., Ltd.) were mixed with stirring, and the mixture was dissolved in a solution of methyl ethyl ketone/methyl isobutyl ketone (20/80 by mass). This solution was mixed with 100 parts by mass of TiO₂ (refractive index: 2.54, average diameter: 0.2 μm) as a light scattering particle and adjusted to a solid content of 50% with methyl ethyl ketone/methyl isobutyl ketone (20/80 by mass), whereby a coating solution for scattering member was prepared.

The coating solution for scattering member prepared above was coated on the barrier layer of the organic EL display device to have a thickness of 10 μm at the curing. After drying the solvent, the coated layer was cured using an air-cooled metal halide lamp (manufactured by Eye Graphics Co., Ltd.) of 160 W/cm by irradiating an ultraviolet ray at an illuminance of 400 mW/cm² and an irradiation dose of 300 mJ/cm² to produce a scattering member.

Here, the above preparation not containing a light scattering particle corresponds to a light-transmitting resin. This light light-transmitting resin is used as a binder for a scattering member. In order to measure the refractive index of this light-transmitting resin, a mixture in which TiO₂ was omitted from the blending of Example 5 was prepared to produce a coating solution for a light-transmitting resin. This coating solution was coated and cured on a glass substrate to form a film of the light-transmitting resin. The refractive index of the film was measured by spectral reflectance film thickness meter, whereby the refractive index of the formed film was found to be 1.70.

Furthermore, based on the blending of the scattering member in Example 5, scattering members in which a thickness and a filling rate of a light scattering particle was changed were produced, whereby organic EL display devices of Examples 6 to 10 and Comparative Examples 3 to 7 were produced.

### Comparative Example 1

In Comparative Example 1, an adhesive having no light diffusibility was produced in accordance with the following blending ratio.

| | |
|---|---|
| Alicyclic epoxy resin: | 100 parts by mass |
| CELLOXIDE 2081 (produced by | |
| Daicel Chemical Industries, | |
| Ltd.) | |
| 2-Ethyl-4-methylimidazole | 4 parts by mass |
| (produced by Shikoku Corp.) | |
| 2,4-Diamino-6-vinyl-s- | 10 parts by mass |
| triazine isocyanuric acid | |
| adduct | |

In Comparative Example 1, the obtained adhesive is coated on the barrier layer of the organic EL to a thickness of 10 μm, and a transparent substrate was laminated thereto.

### Comparative Example 2

In Comparative Example 2, a light diffusing film was produced according to the following production method.

As for the light-transmitting resin constituting the light diffusing layer, 100 parts by mass of zirconium oxide ultrafine particle dispersion-containing hardcoat coating solution (DESOLITE KZ-7114A, produced by JSR) and 57 parts by mass of a polymerizable monomer (polymerizable compound) which is a material of light-transmitting resin (DPHA, produced by Nippon Kayaku Co., Ltd.) were mixed with stirring, and the mixture was dissolved in a solution of methyl ethyl ketone/methyl isobutyl ketone (20/80 by mass). This solution was mixed with 17 parts by mass of polymethyl methacrylate-based bead (MX150, produced by Soken Chemical & Engineering Co., Ltd., average diameter: 1.5 μm, refractive index: 1.49) as a light-transmitting fine particle and adjusted to a solid content of 50% with methyl ethyl ketone/methyl isobutyl ketone (20/80 by mass), whereby a coating solution for light diffusing layer was prepared. The obtained coating solution for light diffusing layer was coated on a triacetyl cellulose film (TD-80U, produced by Fujifilm Corp.) such that the coated amount of the 1.5 μm polymethyl methacrylate-based bead became 0.4 g/m². After drying the solvent, the coated layer was cured using an air-cooled metal halide lamp (manufactured by Eye Graphics Co., Ltd.) of 160 W/cm by irradiating an ultraviolet ray at an illuminance of 400 mW/cm² and an irradiation dose of 300 mJ/cm² to produce a light diffusing film.

In Comparative Example 2, the adhesive having no light diffusibility was coated on the barrier layer to a thickness of 10 μm, and a transparent substrate was laminated thereto. Furthermore, the adhesive having no light diffusibility was coated thereon to a thickness of 10 μm, and the light diffusing film was laminated thereto such that the triacetyl cellulose film substrate came into contact with the adhesive.

In the foregoing pages, working examples of the present invention are described, but the present invention is not limited to the conditions and constructions in these Examples and various changes or modifications can be made. For example, the scattering material and binder material constituting the scattering member of each Example are merely exemplary examples.

An image was displayed on the organic EL display device and the angle distribution of brightness was measured using EZ Contrast 160D manufactured by ELDIM. The total emission quantity was calculated from the measured value, and the percentage change between the total light emission quantity when not using a scattering member and the total light quantity when using a scattering member was determined as a rate of increase in the light extraction. Furthermore, the front brightness was evaluated with an eye by the following four criteria.

| | |
|---|---|
| AA: | Very bright. |
| A: | Bright. |
| B: | Slightly dark. |
| C: | Dark. |

Also, an image was displayed on the organic EL display device, and the image blur was evaluated by the following three criteria.

| | |
|---|---|
| A: | Image blur was not recognized at all. |
| B: | Image was slightly blurred. |
| C: | Image blur was recognized. |

Whether the finished display was good or bad was evaluated by the following three criteria from the standpoint that the brightness was enhanced and the image blur was not recognized.

| | |
|---|---|
| A: | AA in brightness and A or B in image blur. |
| B: | AA, A or B in brightness and A or B in image |
| | blur. |
| C: | C in either brightness or image blur. |

The basic constructions of Comparative Examples 1 and 2, Examples 1 to 10 and Comparative Examples 3 to 7 are shown in Table 1. In addition, with respect to Examples 1 to 10 and Comparative Examples 3 to 7, kinds and refractive indexes of binders and materials, film thicknesses and filling rates of light scattering particles constituting scattering members are summarized in Table 2, Herein, particles 1 to 3 as the materials of the light scattering particles in Table 2 represent the following materials.

Particle 1:

Polymethyl methacrylate-based bead

(MX150, produced by Soken Chemical & Engineering Co., Ltd., average diameter: 1.5 μm, refractive index; 1.49)

Particle 2:

Benzoguanamine-based bead (EPOSTAR MS, produced by Nippon Shokubai Co., Ltd., average diameter: 1.0 μm, refractive index: 1.66)

Particle 3:

TiO₂

(average diameter: 0.2 μm, refractive index: 2.54)

The magnitudes of the filling rates in the following table are represented by the blending amounts of the light scattering particles shown in the preparations of Examples to 10 and Comparative Examples 3 to 7. By coating a self-adhesive agent, adhesive or light-transmitting resin having light scattering property, an organic EL display device with enhanced brightness and less image blur was obtained.

TABLE 1

| | Construction |
|---|---|
| Comparative | On the barrier layer of the organic EL, an adhesive |
| Example 1 | not containing a light scattering particle is coated, and |
| | a transparent substrate is laminated thereon. |
| Comparative | On the barrier layer of the organic EL, a light |
| Example 2 | diffusing film consisting of a scattering member and a |
| | substrate is laminated through an adhesive between the |
| | substrate and the barrier layer. |
| Examples 1 to 10 | On the barrier layer of the organic EL, a scattering |
| Comparative | member consisting of a light scattering particle and a |
| Examples 3 to 7 | binder is formed, and a transparent substrate is |
| | laminated thereon. |

TABLE 2

| | | | Light Scattering Particle | | |
|---|---|---|---|---|---|
| | | | | Film | |
| | | | | Thickness | |
| | Binder | | | (Scattering | Filling |
| | | Refractive | | Member) | Rate (parts by |
| | Kind | Index | Material | (μm) | mass) |
| Example 1 | Self-adhesive agent | 1.70 | Particle 1 | 10.0 | 17 |
| Example 2 | Self-adhesive agent | 1.45 | Particle 2 | 10.0 | 17 |
| Example 3 | Adhesive | 1.70 | Particle 1 | 10.0 | 17 |
| Example 4 | Adhesive | 1.45 | Particle 2 | 10.0 | 17 |
| Example 5 | Light-transmitting resin | 1.70 | Particle 3 | 10.0 | 100 |
| Example 6 | Light-transmitting resin | 1.70 | Particle 3 | 0.5 | 100 |
| Example 7 | Light-transmitting resin | 1.70 | Particle 3 | 1.0 | 100 |
| Example 8 | Light-transmitting resin | 1.70 | Particle 3 | 3.0 | 35 |
| Example 9 | Light-transmitting resin | 1.70 | Particle 3 | 7.0 | 15 |
| Example 10 | Light-transmitting resin | 1.70 | Particle 3 | 10.0 | 10 |
| Comparative | Light-transmitting resin | 1.70 | Particle 3 | 0.2 | 100 |
| Example 3 | | | | | |
| Comparative | Light-transmitting resin | 1.70 | Particle 3 | 0.4 | 100 |
| Example 4 | | | | | |
| Comparative | Light-transmitting resin | 1.70 | Particle 3 | 12.0 | 100 |
| Example 5 | | | | | |
| Comparative | Light-transmitting resin | 1.70 | Particle 3 | 15.0 | 100 |
| Example 6 | | | | | |
| Comparative | Light-transmitting resin | 1.70 | Particle 3 | 20.0 | 100 |
| Example 7 | | | | | |

TABLE 3

| | Rate of Increase | | | |
|---|---|---|---|---|
| | in Light | | | |
| | Extraction (%) | Brightness | Image Blur | Judgment |
| Comparative | 0 | C | A | C |
| Example 1 | | | | |
| Comparative | 5 | A | C | C |
| Example 2 | | | | |
| Example 1 | 3 | B | A | B |
| Example 2 | 3 | B | A | B |
| Example 3 | 3 | B | A | B |
| Example 4 | 3 | B | A | B |
| Example 5 | 5 | A | A | B |
| Example 6 | 5 | A | A | B |
| Example 7 | 20 | AA | A | A |
| Example 8 | 25 | AA | A | A |
| Example 9 | 13 | AA | A | A |
| Example 10 | 5 | A | A | B |
| Comparative | 0 | C | A | C |
| Example 3 | | | | |
| Comparative | 0 | C | A | C |
| Example 4 | | | | |
| Comparative | 0 | C | A | C |
| Example 5 | | | | |
| Comparative | −5 | C | A | C |
| Example 6 | | | | |
| Comparative | −10 | C | A | C |
| Example 7 | | | | |

As described in Background Art, the cause of the low light extraction efficiency of a self-emission display device resides in that when light generated inside of the display device becomes incident at a large angle on the interface with an adjacent layer differing in the refractive index, the light is totally reflected and entirely waveguided through the inside of the display derive and cannot be extracted to the outside.

On the other hand, by introducing a scattering member comprising a binder and a light scattering particle into an organic EL display device, it becomes possible to extract the light to the outside. That is, the traveling direction of light caused to be waveguided through layers due to total reflection is bent by the action of light scattering, whereby light extraction to the outside can be realized.

At this time, by setting the refractive index of the binder of the scattering member to be equal to or greater than the refractive index of the organic light-emitting layer, light being waveguided inside of a high refractive index layer including the organic light-emitting layer can be extracted. Also, at this time, by scattering light on the upper electrode, the distance between the light emitting point and the scattering position can be narrowed and the resolution of an image can be prevented from deteriorating due to light scattering. Furthermore, in order to more elevate the light extraction efficiency, it is preferred to increase the number of occurrences of light scattering. To this end, the number of occurrences of total reflection in a high refractive index layer including the organic light-emitting layer is preferably increased, which can be realized by thinning the high refractive index layer including the organic light-emitting layer.

In addition, the light extraction efficiency can be enhanced also by setting the refractive index of the binder of the binding member to be lower than that of the organic light-emitting layer and setting the refractive index of the light scattering particle to be equal to that of the organic light-emitting layer. In this case, total reflection occurs at the interface between the upper electrode and the scattering member, but the light scattering particle having a high refractive index is in contact with the interface to allow for occurrence of light scattering at the contact portion, so that light reflected by total reflection can be extracted to the outside.

The entire disclosure of each and every foreign patent application from which the benefit of foreign priority has been claimed in the present application is incorporated herein by reference, as if fully set forth.

What is claimed is:

1. A scattering member, comprising:
a binder; and
a light scattering particle,
wherein the scattering member is used for an organic electroluminescent display device.

2. The scattering member according to claim 1,
wherein the binder contains a liquid.

3. The scattering member according to claim 1,
wherein the binder contains a self-adhesive agent.

4. The scattering member according to claim 1,
wherein the binder contains an adhesive.

5. The scattering member according to claim 1,
wherein the binder contains a light-transmitting resin.

6. The scattering member according to claim 1,
wherein a refractive index of the binder is 1.65 or more.

7. The scattering member according to claim 1,
wherein the binder contains at least one kind of an inorganic fine particle selected from the group consisting of ZrO₂, TiO₂, ZnO and SnO₂.

8. The scattering member according to claim 1,
wherein a refractive index of the light scattering particle is 1.55 or less or 2.1 or more.

9. The scattering member according to claim 1,
wherein an average diameter of the light scattering particle is 2.0 μm or less.

10. The scattering member according to claim 1,
wherein an average diameter of the light scattering particle is from 0.2 to 0.5 μm.

11. The scattering member according to claim 1, which has a film thickness of from 0.5 to 10.0 μm.

12. The scattering member according to claim 1, which has a film thickness of from 1.0 to 7.5 μm.

13. The scattering member according to claim 1,
wherein a refractive index of the binder is 1.5 or less.

14. The scattering member according to claim 13,
wherein the binder contains at least one kind of a fine particle selected from the group consisting of a silica fine particle and a hollow silica fine particle.

15. The scattering member according to claim 13,
wherein a refractive index of the light scattering particle is 1.65 or more.

16. The scattering member according to claim 13,
wherein an average diameter of the light scattering particle is 2.0 μm or less.

17. The scattering member according to claim 13,
wherein an average diameter of the light scattering particle is from 0.2 to 0.5 μm.

18. The scattering member according to claim 13, which has a film thickness of from 0.5 to 10.0 μm.

19. The scattering member according to claim 13, which has a film thickness of from 1.0 to 7.5 μm.

20. An organic electroluminescent display device, comprising:
a substrate;
a lower electrode;
an organic electroluminescent layer;
an upper electrode; and
a transparent substrate, in this order,
wherein the scattering member according to claim 1 is in contact with the upper electrode.

21. An organic electroluminescent display device, comprising:
a substrate;
a lower electrode;
an organic electroluminescent layer;
an upper electrode;
a barrier layer; and
a transparent substrate, in this order,
wherein the scattering member according to claim 1 is in contact with the barrier layer.
